(19) United States
(12) Patent Application Publication
(10) Pub. No.: US 2013/0021474 A1
(43) Pub. Date: Jan. 24, 2013

(54) ROLLING-SHUTTER IMAGING SYSTEM WITH SYNCHRONIZED SCANNING ILLUMINATION AND METHODS FOR HIGHER-RESOLUTION IMAGING

(71) Applicants: Byron B. Taylor, Tucson, AZ (US); Robert Rinker, Tucson, AZ (US); Ted Lynch, Tucson, AZ (US); Robert A. Stein, Tucson, AZ (US)

(72) Inventors: Byron B. Taylor, Tucson, AZ (US); Robert Rinker, Tucson, AZ (US); Ted Lynch, Tucson, AZ (US); Robert A. Stein, Tucson, AZ (US)

(73) Assignee: Raytheon Company, Waltham, MA (US)

(21) Appl. No.: 13/186,582

(22) Filed: Jul. 20, 2011

(51) Int. Cl. H04N 7/18

(52) U.S. Cl. 348/144; 348/E07.085

(57) ABSTRACT

Embodiments of a rolling-shutter imaging system with synchronized scanning illumination and methods for higher-resolution imaging are generally described herein. In some embodiments, the imaging system includes a focal plane array (FPA) and a read-out integrated circuit (ROIC) configured to activate only a portion of the FPA during an integration time. The imaging system also includes a scanner synchronized with the ROIC to illuminate only a portion of a sensor field-of-view (FOV) of the FPA within a scene that corresponds to at least the activated portion of the FPA. The imaging system may also include beamforming optics to generate a beam of light to illuminate the portion of the sensor FOV corresponding to portion of the FPA that is activated.

### GOVERNMENT RIGHTS

This invention was made not with United States Government support. The United States Government does not have any rights in this invention.

### TECHNICAL FIELD

Embodiments pertain to imaging systems. Some embodiments relate to rolling-frame or rolling-shutter imaging systems. Some embodiments pertain to imaging systems suitable for gimbaled applications. Some embodiments pertain to short-wave infrared (SWIR) imaging systems including imaging systems for air-based platforms and missile seekers.

### BACKGROUND

The ability of an imaging system to generate higher-resolution images is highly dependent on the intensity of the illumination source as well as the sensitivity of the focal-plane array (FPA). In many conventional imaging systems, the illumination source illuminates the entire field-of-view (FOV) of the FPA and consumes a significant amount of power to provide the necessary intensity for higher-resolution imaging. This amount of power consumption becomes even more significant for longer-range imaging, and particularly for SWIR imaging. To reduce power consumption, lower intensity illumination sources have been used with more sensitive FPAs, however the cost of an FPA increases dramatically with its sensitivity.

Thus, there are general needs for imaging systems and methods for higher-resolution imaging and longer-range imaging with reduced power consumption. There are general needs for imaging systems and methods for higher-resolution imaging and longer-range imaging that use lower intensity illuminators. There are also general needs for imaging systems and methods for higher-resolution imaging and longer-range imaging that use less expensive and less sensitive FPAs. There are also general needs for higher-resolution imaging systems that are lighter weight and suitable for portable applications including air-based platforms.

### BRIEF DESCRIPTION OF THE DRAWINGS

FIG. 1 is a functional diagram of an imaging system in accordance with some embodiments;

FIG. 2A is a diagram of a gimbaled imaging system in accordance with some embodiments;

FIG. 2B is a diagram of a gimbaled imaging system in accordance with some other embodiments;

FIG. 3 illustrates the operation the imaging system of FIG. 1 in accordance with some embodiments; and

FIG. 4 illustrates an air-based platform in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 is a functional diagram of an imaging system in accordance with some embodiments. Imaging system 100 may include, among other things, an FPA 102, a read-out integrated circuit (ROIC) 104, a scanner 106, beamforming optics 108, and an illuminator 110. In some embodiments, the imaging system 100 may also include a controller 112 for configuring other elements of the imaging system 100 to perform the various operations described herein. In accordance with embodiments, the ROIC 104 may be configured to activate only a portion of the FPA 102 during an integration time and the scanner 106 may be synchronized with the ROIC 104 to illuminate only a portion of a sensor field-of-view (FOV) 121 of the FPA 102 within a scene 120 that corresponds to at least the activated portion of the FPA 102.

The beamforming optics 108 may provide a beam of light 107 to the scanner 106 that has a beam divergence that is matched to the active area of the FPA 102. In some embodiments, the beamforming optics 108 may include a collimator to provide substantially collimated light to the scanner 106 to illuminate the active area of the FPA 102.

In these embodiments, the portion of the sensor FOV 121 that is illuminated by scanner 106 is less than an entire sensor FOV 121. The scanner 106 is configured to illuminate the portion of the sensor FOV 121 with a beam of light 124 having a shape that corresponds substantially to the activated portion of the FPA 102 in the sensor FOV 121. The illuminator 110 may be configured to generate light 109 for the beamforming optics 108. The light 109 generated by the illuminator 110 may be either coherent or non-coherent depending on the embodiment.

In these embodiments, because the beam of light 124 directed by the scanner 106 is synchronized with the portion of the FPA 102 that is active, only a portion 122 of the sensor FOV 121 that corresponds to the activated portion of the FPA 102 needs to be illuminated at a time. Thus, the amount of energy needed for illumination may be greatly reduced. This allows lower-cost and lighter-weight illuminators to be used. Furthermore, longer-range and higher-resolution imaging may be achieved with lower-intensity illuminators. Accordingly the imaging system 100 may be more suitable for portable imaging applications where energy consumption is a concern.

In some embodiments, the beam of light 107 provided by the beamforming optics 108 to the scanner 106 may have a width 125 of substantially the sensor FOV 121 and a height 127 in the sensor FOV 121 of substantially the portion of the FPA 102 that are activated. As discussed in more detail below, the height 127 may be a height of one or more activated rows 103 of elements of the FPA 102.

In some embodiments, the beamforming optics 108 may change the width 125 and height 127 of the beam of light 124 the based the size of the sensor FOV 121, which may vary depending on a range of a target to be imaged. In some of these embodiments, the imaging system 100 may include circuitry for determining a range to a target of interest and the controller 112 may configure the beamforming optics 108 accordingly.

In some embodiments, the beam of light 124 comprises coherent light. In other embodiments, the beam of light 124 comprises collimated non-coherent light. Among other things, the use of coherent or non-coherent light may depend on the particular type of scanner 106 used in the imaging system 100. These embodiments are discussed in more detail below.

In some embodiments, the FPA 102 comprises a plurality of rows 103 of elements and the ROIC 104 is configured to activate one or more rows 103 of the FPA 102 during an integration time in a row-by-row fashion. The scanner 106 may be configured to synchronously illuminate at least the portion 122 of the sensor FOV 121 that corresponds to the one or more activated rows 103 and not illuminate at least some portions of the sensor FOV 121 that correspond to inactive rows 113.

In some embodiments, the ROIC 104 may be configured to activate only a single row 103 of the FPA 102. In other embodiments, the ROIC 104 may be configured to activate more than one row 103 of the FPA 102, but less than all rows 103 of the FPA 102. The scanner 106 may be synchronized with the ROIC 104 to illuminate at least the portion of the sensor FOV 121 that corresponds to at least the one or more active rows 103. This is unlike conventional imagers that illuminate the entire sensor FOV 121.

In some embodiments, the scanner 106 may illuminate portions of the sensor FOV 121 that corresponds to more rows than the currently active one or more rows of the FPA 102 (e.g., the currently active row or rows 103 as well as one or more non-active rows that are adjacent to the active row or rows). In this way less precision scanning and beamforming may be needed. In these embodiments, for each integration time, less than the entire sensor FOV 121 is illuminated.

As used herein, the terms ‘row’ and ‘column’ may be interchanged without affecting the scope of the embodiments. Although the term ‘row’ is generally used herein to conventionally describe a set of elements of the FPA 102 in either the x-direction or in the horizontal direction, it may equally refer to a set of elements of the FPA 102 provided in either the y-direction or a vertical direction, which is conventionally referred to as a column.

In some embodiments, the ROIC 104 may be configured to generate an integrator line-sync signal 105 and the scanner 106 may be synchronized with the integrator line-sync signal 105. Based on the integrator line-sync signal 105, the scanner 106 may be configured to scan the sensor FOV 121 to illuminate the portion of the sensor FOV 121 corresponding to at least the currently active one or more rows 103 of the FPA 102 in a row-by-row fashion. In these embodiments, the scanner 106 is synchronized to the ROIC 104 and may be driven by the output of the ROIC 104.

In some other embodiments, the scanner 106 may be configured to generate a synchronization signal for the ROIC 104 and the ROIC 104 may be synchronized with this synchronization signal. The ROIC 106 may be configured to activate one or more rows 103 of the FPA 102 for the integration time in a row-by-row fashion in response to the synchronization signal. The scanner 106 may be synchronized with this synchronization signal and configured to scan the sensor FOV 121 to illuminate the portion of the sensor FOV 121 corresponding to at least the currently active one or more rows 103 of the FPA 102 in a row-by-row fashion. In these embodiments, the ROIC 104 is synchronized to an output from the scanner 106.

In some embodiments, the portion of the FPA 102 that is illuminated comprises one or more rows 103 elements that may be referred to as either unit cells or pixel elements. When a row 103 is activated, the pixel elements or unit cells of the row are configured to collect and integrate photons of light. After the integration time, the ROIC 104 is configured deactivate the row and to read out values of each of the unit cells or pixel elements for subsequent image generation. The unit cells, for example, may comprise charge-coupled devices (CCDs). The pixel elements, for example may comprise complementary metal-oxide semiconductor (CMOS) sensor devices. In some embodiments, charge-injection devices (CIDs) may also be used for unit cells or pixel elements. Other photon collection and integration elements may also be used.

In some embodiments, the ROIC 104 and the FPA 102 are configured to operate in accordance with a rolling-shutter image acquisition and generation technique. In these embodiments, the scanner 106 and ROIC 104 are synchronized so that the scanner 106 illuminates the portion of the sensor FOV 121 that corresponds to at least the portion of the FPA 102 that is activated by the ROIC 104 in either a row-by-row or a column-by-column fashion. In accordance with the rolling-shutter image acquisition and generation technique, the ROIC 104 may generate an output image 115 by combining the integrated results of all the rows 103. In these embodiments, the ROIC 104 may activate one or more rows 103 of the FPA 102 in a row-by-row manner and allow the devices of the currently active one or more rows 103 time to integrate the incident light. After the integration time, the ROIC 104 may turn-off the active rows for read-out and may activate the next one or more rows 103 for exposure.

In some embodiments, once all rows are read out (i.e., a scan is completed), the output image 115 may be generated by combining the integration results of each row 103. In this way, a new output image 115 may be generated for each scan. In some other embodiments, the output image 115 may be updated in a row-by-row manner (i.e., after each row is read out).

In some embodiments, the controller 112 may be configured to perform various operations described herein. In some embodiments, the controller 112 may be configured to perform an initial synchronization between the scanner 106 and the ROIC 104. The initial synchronization may synchronize the portion of the sensor FOV 121 that is illuminated by the scanner 106 with the one or more rows 103 of the FPA 102 to be activated. In some embodiments, the initial synchronization may include configuring the scanner 106 to generate a synchronization pulse for reception within one or more rows of the FPA 102. In these embodiments, the entire FPA 102 may be initially activated to identify the synchronization pulse. In some embodiments, the initial synchronization may include configuring the scanner 106 and the ROIC 104 to free-run and changing a delay in the integration times until synchronization is achieved. Other techniques for initial synchronization may also be used.

In some embodiments, the scanner 106 may comprise a galvometric scanner comprising one or more moving mirrors. In these embodiments, either coherent or non-coherent light may be used.

In some embodiments, the scanner 106 may comprise a polygon scanner comprising a polygon configured to rotate or spin. In these embodiments, either coherent or non-coherent light may be used.

In some embodiments, the scanner 106 may comprise a Risely set scanner comprising a prism configured to rotate. In these embodiments, either coherent or non-coherent light may be used.

In some embodiments, the scanner 106 may comprise a rotating grating scanner comprising a diffraction grating configured to rotate. In these embodiments, coherent light is used.

In some embodiments, the scanner 106 may comprise an optical phased array. In these embodiments, the optical properties of a surface are dynamically controlled on a microscopic scale to steer the direction the beam of light 124 without any moving parts.

In some embodiments, the scanner 106 may comprise a disk scanner comprising a holographic disk configured to rotate or spin. In these embodiments, coherent light is used.

In these various embodiments, one or more moving elements of the scanner 106 may be configured to move, rotate or spin in sync with the integration performed by the ROIC 104. Other types of scanners may also be used. The particular type of scanner selected for use in the imaging system 100 may depend on various system requirements.

In some embodiments, the illuminator 110 may be configured to generate coherent light 109 for the beamforming optics 108. In other embodiments, the illuminator 110 may be configured to generate non-coherent light 109 for the beamforming optics 108. The illuminator 110 may comprise one of a near infrared (NIR) light source, a short-wave infrared (SWIR) light source, a Laser light source, or a visible light source.

In some embodiments, the beam of light 109 may be collimated. In some embodiments, a separate collimator may be included to collimate the beam of light 109 either before or after the beamforming optics 108. In accordance with embodiments, wavelengths of light ranging from as small as 0.3 microns or less to up to 2.5 microns and greater may be generated by the illuminator 110. The type of FPA 102 may be selected to be sensitive to the particular wavelengths of light generated by the illuminator 110 as well as other system requirements.

In some embodiments, the illuminator 110 may comprise a vertical-cavity surface-emitting laser (VCSEL) comprising an array of laser diodes. Rows of the laser diodes are configured to be activated in a row-by-row fashion to generate light to illuminate the portion 122 of the sensor FOV 121 that corresponds to the one or more active rows 103 of the FPA 102. In these embodiments that use a VCSEL for the illuminator 110, a separate scanner 106 may not be required reducing or eliminating the use of moving parts associated with some of the scanners discussed above.

In some embodiments, the imaging system 100 may be part of a SWIR imager suitable for nighttime operations. In some embodiments, the imaging system 100 may be suitable for use in turret-based systems. In other embodiments, the imaging system 100 may be suitable for air-based platforms.

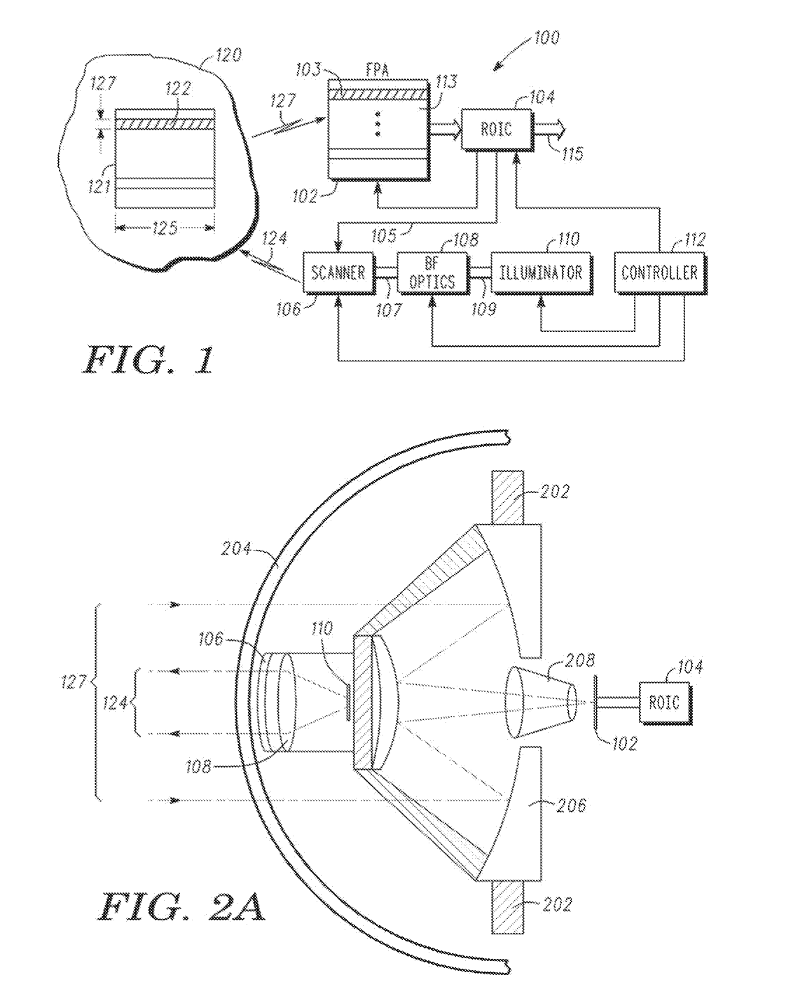

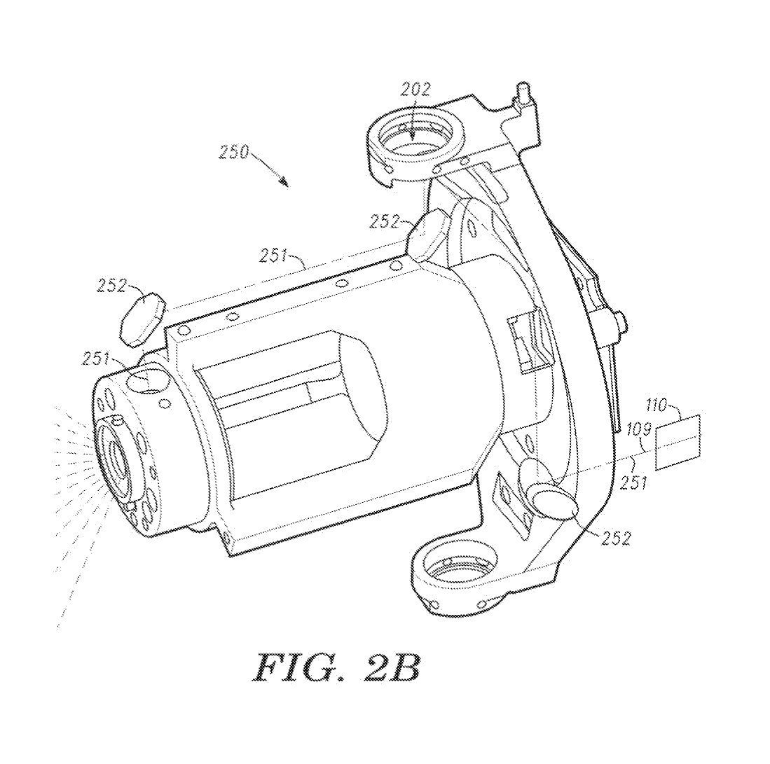

FIG. 2A is a diagram of a gimbaled imaging system in accordance with some embodiments. Gimbaled imaging system 200 may include an FPA 102, a read-out integrated circuit (ROIC) 104, a scanner 106, beamforming optics 108, and an illuminator 110 configured to operate as described with respect to imaging system 100 (FIG. 1). Gimbaled system 200 may also include gimbals 202, dome 204, mirror 206, and imager optics 208, among other things. In these embodiments, the FPA 102, the ROIC 104, the scanner 106, the beamforming optics 108, and the illuminator 110 are located on-gimbal.

In some other embodiments, the FPA 102, the ROIC 104, the scanner 106, and the beamforming optics 108 may be located on-gimbal, and the illuminator 110 may be located off-gimbal. The light 109 generated by the illuminator 110 may be provided via a Coudé path through the gimbal axes 202. In these embodiments, the Coudé path may include an optical fiber path to carry the light generated by the illuminator 110.

FIG. 2B is a diagram of a gimbaled imaging system 250 in accordance with some other embodiments. In these embodiments, the FPA, the ROIC, the scanner, and the beamforming optics may be located on-gimbal, and the illuminator 110 may be located off-gimbal. The light 109 generated by the illuminator 110 may be provided via a Coudé path 251 through the gimbal axes as shown. In some embodiments, Coudé path 250 may include reflective elements 252 (e.g., mirrors) to provide the light 109 generated by the illuminator 110 through the Coudé path 251. In some embodiments, the Coudé path 251 may include an optical fiber path to carry the light generated by the illuminator 110.

Although embodiments described herein illustrate the applicability of imaging system 100 to gimbaled systems, the scope of the invention is not limited in this respect. In some embodiments, imaging system 100 may be used in non-gimbaled systems such as strap-down sensors.

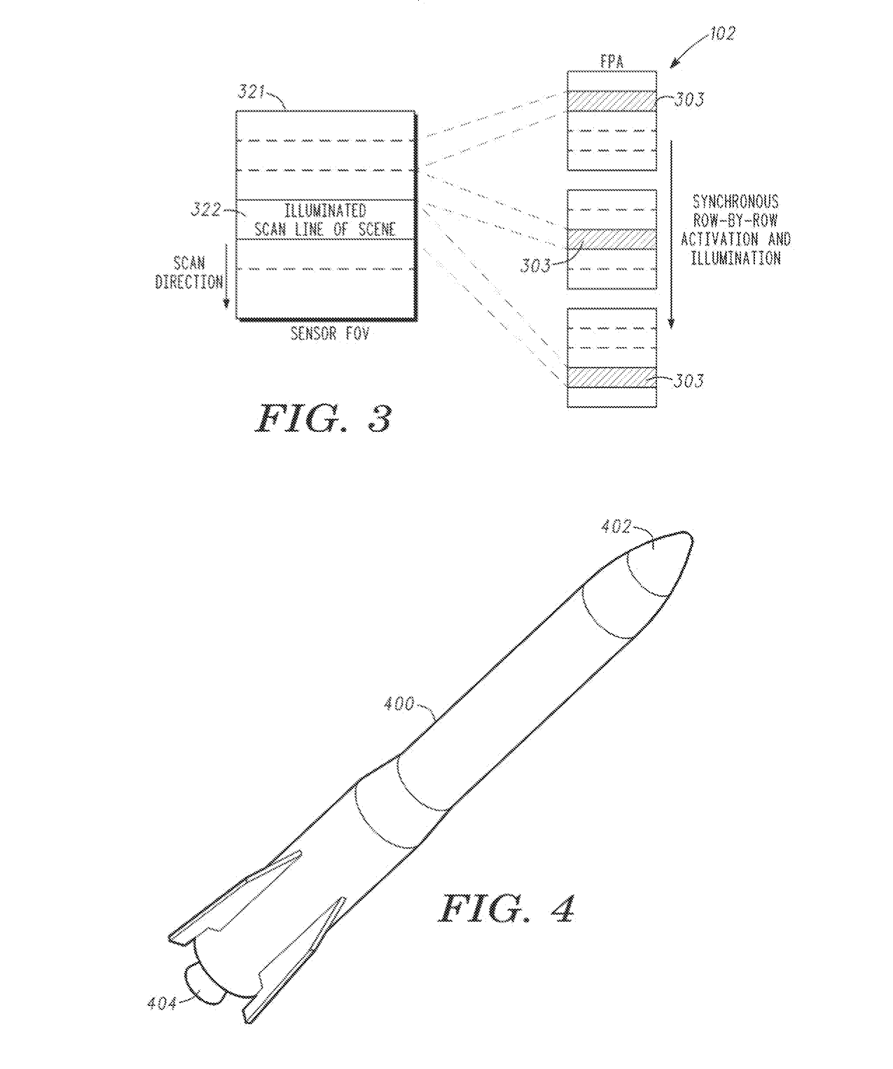

FIG. 3 illustrates the operation the imaging system of FIG. 1 in accordance with some embodiments. As shown in FIG. 3, the scanner 106 (FIG. 1) is synchronized with the ROIC 104 (FIG. 1) to illuminate only a portion 322 of a sensor FOV 321 that corresponds to at least the activated portion 303 of the FPA 102. As further illustrated in FIG. 3, the portion 322 of the sensor FOV 321 that is illuminated by scanner 106 is less than an entire sensor FOV 321. The scanner 106 is configured to illuminate the portion of the sensor FOV 321 with beam of light having a shape that corresponds substantially to the activated portion 303 of the FPA 102 in the sensor FOV 321. In these embodiments, the ROIC 104 and the FPA 102 are configured to operate in accordance with the rolling-shutter image acquisition and generation technique as illustrated in FIG. 3.

As further illustrated in FIG. 3, the ROIC 104 is configured to activate one or more portions 303 of the FPA 102 during an integration time in a row-by-row fashion and the scanner 106 is configured to synchronously illuminate at least the portion 322 of the sensor FOV 321 that corresponds to the activated portions (e.g., one or more rows) and not illuminate at least some portions of the sensor FOV 121 that correspond to the inactive portion.

FIG. 4 illustrates an air-based platform in accordance with some embodiments. The air-based platform 400 may include an imaging system 402 to perform imaging and a propulsion system 404 to propel the air-based platform 400. Imaging system 100 (FIG. 1), gimbaled imaging system 200 (FIG. 2A) and gimbaled imaging system 250 (FIG. 2B) may be suitable for use as imaging system 402.

In some embodiments, the air-based platform 400 may be a missile and the imaging system 402 may be a SWIR imaging system. In these embodiments, the imaging system 402 may be a gimbaled imaging system and may be part of a seeker configured target imaging including acquisition, target tracking and/or target identification. In some embodiments, the air-based platform 400 may be an unmanned aerial vehicle (UAV) and the imaging system 402 may be a gimbaled-imaging system that is configured for imaging and surveillance. In other embodiments, non-gimbaled imaging systems may also be used including strap-down sensor systems.

Although imaging system 100 (FIG. 1) is illustrated as having several separate functional elements, one or more of the functional elements may be combined and may be implemented by combinations of software-configured elements, such as processing elements including digital signal processors (DSPs), and/or other hardware elements. For example, the ROIC 104 and the controller 112 may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of imaging system 100 may refer to one or more processes operating on one or more processing elements.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An imaging system comprising:
a read-out integrated circuit (ROIC) configured to activate only a portion of a focal plane array (FPA) during an integration time; and
a scanner synchronized with the ROIC to illuminate only a portion of a sensor field-of-view (FOV) of the FPA within a scene that corresponds to at least the activated portion of the FPA.

2. The imaging system of claim 1 wherein the portion of the sensor FOV that is illuminated by scanner is less than an entire sensor FOV, and
wherein the scanner is configured to illuminate the portion of the sensor FOV with a beam of light having a shape that corresponds substantially to the activated portion of the FPA in the sensor FOV.

3. The imaging system of claim 2 further comprising beamforming optics to generate the beam of light to provide to the scanner, the beam of light provided by the scanner having a width of substantially the sensor FOV and a height in the sensor FOV of substantially the portion of the FPA that are activated,
wherein the beamforming optics is configured to provide a beam of light having a beam divergence that is matched to the activated portion of the FPA.

4. The imaging system of claim 3 wherein the FPA comprises a plurality of rows,
wherein the ROIC is configured to activate one or more rows of the FPA during an integration time in a row-by-row fashion, and
wherein the scanner is configured to synchronously illuminate at least the portion of the sensor FOV that corresponds to the one or more activated rows and not illuminate at least some portions of the sensor FOV that correspond to inactive rows.

5. The imaging system of claim 4 wherein the ROIC is configured to generate an integrator line-sync signal, and
wherein the scanner is synchronized with the integrator line-sync signal and configured to scan the sensor FOV to illuminate the portion of the sensor FOV corresponding to at least the currently active one or more rows of the FPA in a row-by-row fashion.

6. The imaging system of claim 4 wherein the scanner is configured to generate a synchronization signal for the ROIC,
wherein the ROIC is synchronized with the synchronization signal and configured to activate one or more rows of the FPA for the integration time in a row-by-row fashion in response to the synchronization signal, and
wherein the scanner is synchronized with the synchronization signal and configured to scan the sensor FOV to illuminate the portion of the sensor FOV corresponding to at least the currently active one or more rows of the FPA in a row-by-row fashion.

7. The imaging system of claim 3 wherein the portion of the FPA that is illuminated comprises one or more rows of unit cells or pixel elements,
wherein when a row is activated, the pixel elements or unit cells of the row are configured integrate photons of light, and
wherein after the integration time, the ROIC is configured deactivate the row and to read out values of each of the unit cells or pixel elements for subsequent image generation.

8. The imaging system of claim 3 wherein the ROIC and the FPA are configured to operate in accordance with a rolling-shutter image acquisition and generation technique,
wherein the scanner and ROIC are synchronized so that the scanner illuminates the portion of the sensor FOV that corresponds to at least the portion of the FPA that is activated by the ROIC in a row-by-row fashion.

9. The imaging system of claim 3 further comprising a controller 112 to perform an initial synchronization between the scanner and the ROIC,
wherein the initial synchronization is to synchronize the portion of the sensor FOV that is illuminated by the scanner with to the one or more rows of the FPA to be activated.

10. The imaging system of claim 3 wherein the scanner comprises a galvometric scanner comprising one or more moving mirrors.

11. The imaging system of claim 3 wherein the scanner comprises a polygon scanner comprising a polygon configured to rotate or spin.

12. The imaging system of claim 3 wherein the scanner comprises a Risely set scanner comprising a prism configured to rotate.

13. The imaging system of claim 3 wherein the scanner comprises a rotating grating scanner comprising a diffraction grating configured to rotate.

14. The imaging system of claim 3 wherein the scanner comprises an optical phased array.

15. The imaging system of claim 3 wherein the scanner comprises a disk scanner comprising a holographic disk configured to rotate or spin.

16. The imaging system of claim 3 further comprising an illuminator configured to generate light for the beamforming optics, and
wherein the illuminator comprises one of a near infrared (NIR) light source, a short-wave infrared (SWIR) light source, a Laser light source, and a visible light source.

17. A method of generating an image comprising:
activating only a portion of focal plane array (FPA) during an integration time; and
synchronously illuminating only a portion of a sensor field-of-view (FOV) of the FPA within a scene that corresponds to at least the activated portion of the FPA.

18. The method of claim 17 wherein the portion of the sensor FOV that is illuminated is less than an entire sensor FOV, and
wherein the method further comprises generating beam of light having a width of substantially the sensor FOV and a height in the sensor FOV of substantially one or more rows of the FPA that are activated.

19. The method of claim 18 further comprising synchronizing a scanner with a read-out integrated circuit (ROIC) that is coupled to the FPA to allow the scanner to synchronously illuminate only the portion of the sensor FOV that corresponds to at least the activated portion of the FPA.

20. A gimbaled imaging system comprising:
a focal plane array (FPA);
a read-out integrated circuit (ROIC) configured to activate only a portion of the FPA during an integration time;
a scanner synchronized with the ROIC to illuminate only a portion of a sensor field-of-view (FOV) of the FPA within a scene that corresponds to at least the activated portion of the FPA;
beamforming optics to generate a beam of light to provide to the scanner to illuminate the portion of the sensor FOV corresponding to portion of the FPA that is activated; and
an illuminator configured to generate light for the beamforming optics,
wherein at least the FPA, the ROIC, the scanner, and the beamforming optics are located on-gimbal.

21. The gimbaled imaging system of claim 20 wherein the illuminator is located on a gimbal.

22. The gimbaled imaging system of claim 20 wherein the illuminator is located off-gimbal and light generated by the illuminator is provided via the Coudé path through gimbal axes, and
wherein the gimbaled imaging system further includes an optical fiber path to carry the light generated by the illuminator through the Coudé path.

23. An air-based platform comprising:
a gimbaled imaging system; and
a propulsion system to propel the air-based platform,
wherein the gimbaled imaging system comprises a read-out integrated circuit (ROIC) configured to activate only a portion of a focal plane array (FPA) during an integration time, a scanner synchronized with the ROIC to illuminate only a portion of a sensor field-of-view (FOV) of the FPA that corresponds to at least the activated portion of the FPA, beamforming optics to generate a beam of light to provide to the scanner to illuminate the portion of the sensor FOV corresponding to portion of the FPA that is activated, and an illuminator configured to generate light for the beamforming optics, and
wherein at least the FPA, the ROIC, the scanner, and the beamforming optics are located on-gimbal.

24. The air-based platform of claim 23 wherein the air-based platform is a missile, the illuminator is a short-wave infrared (SWIR) illuminator and the gimbaled imaging system is part of a seeker configured target imaging.

25. The air-based platform of claim 23 wherein the air-based platform is an unmanned aerial vehicle (UAV) and the gimbaled imaging system is configured for imaging and surveillance.

26. An imaging system comprising:
a read-out integrated circuit (ROIC) configured to activate only a portion of a focal plane array (FPA) during an integration time; and
a vertical-cavity surface-emitting laser (VCSEL) comprising an array of laser diode synchronized with the ROIC to illuminate a portion of a sensor field-of-view (FOV) of the FPA that corresponds to at least the activated portion of the FPA,
wherein rows of the laser diodes are configured to be activated to generate light to illuminate the portion of the sensor FOV that corresponds to one or more active rows of the FPA.

27. The imaging system of claim 26 wherein the portion of the sensor FOV that is illuminated by scanner is less than an entire sensor FOV, and
wherein the system includes beamforming optics configured to provide a beam of light having a beam divergence that is matched to the activated portion of the FPA.
